(19) United States
(12) Patent Application Publication
(10) Pub. No.: US 2005/0264688 A1
(43) Pub. Date: Dec. 1, 2005

(54) Pre-strobo light emission in solid image pickup device

(75) Inventor: Hiroshi Ouchi, Osaka (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/138,498

(22) Filed: May 27, 2005

(30) Foreign Application Priority Data
Jun. 1, 2004 (JP) P2004-163143

(51) Int. Cl. H04N 5/222

(52) U.S. Cl. 348/371

(57) ABSTRACT

An image pickup device according to the present invention comprises at least a strobo for illuminating a photographic subject, a solid imaging element having a plurality of pixels disposed in a two-dimensional matrix shape, a strobo light emission control circuit for controlling the strobo and a sensor drive circuit for controlling storage/readout of a charge of the solid imaging element, wherein the strobo light emission control circuit controls the strobo so that the pre-strobo light emission is carried out prior to the real strobo light emission, and the sensor drive circuit controls the solid imaging element so that the charges stored in the plurality of pixels are mixed and read during the pre-strobo light emission per a predetermined number of pixels.

### BACKGROUND OF THE INVENTION

1. Field of the Invention

The present invention relates to a solid image pickup device having a photoelectric sensing element, an image pickup control device and an image pickup method, more particularly to a technology for pre-strobo light emission of a solid imaging element using a photoelectric sensing element having a focal-plane shutter.

2. Description of the Related Art

In recent years, a photoelectric sensing element achieving a higher pixel density is used in image pick devices such as a video camera, a digital still camera, a mobile camera used in a mobile telephone and the like.

In these devices, image data can be recorded on a recording medium such as a CF (Compact Flash) card, a SD (Secure Digital) card or the like and displayed on a liquid crystal display screen, or printed out and stored.

The image pickup device such as the digital still camera generally comprises a strobo and a flash. When a sufficient volume of light cannot be obtained in an environment such as a dark place or nighttime, the light volume is momentarily increased by light emission using the strobo with respect to a photographic subject so as to photograph the object.

In the image pickup device, exposure conditions of the photographic subject are measured when the image is taken so that an appropriate exposure time and iris are set. More specifically, a solid imaging element has photoelectric sensing elements disposed in a two-dimensional matrix shape, wherein a total volume of received light in the solid imaging element is measured. It is judged if a measured value representing the total volume of received light exceeds or falls below a predetermined target value and the measured value is controlled so as to reach the target value. The control is generally referred to as AE (Automatic Exposure). The strobo photography requires the execution of the AE along with white balance control and focus control such as auto focus.

However, it is difficult to adjust the iris, exposure control, white balance control, and focus control at the exact moment of the strobo light emission. Therefore, in order to overcome the difficulty, the strobo light emission is separated into real strobo light emission and pre-strobo light emission. First, light is emitted by the pre-strobo light emission with respect to the photographic subject prior to the real strobo light emission, and the light volume received from the photographic subject is measured. The respective adjustments are made based on a result obtained by the measurement, and an image is picked up by the real strobo light emission.

The solid imaging element (hereinafter, referred to as CCD) in which CCD (Charge Coupled Device) is incorporated in a pixel region of a matrix type as the photoelectric sensing element has a synchronism in storing electric charges, and therefore, conventionally stored the charges in response to the strobo light emission in general.

In recent years, power consumption is on the increase because number of pixels has been increasing along with the higher pixel density in the solid imaging element. In the digital still camera or mobile camera, a solid imaging element (hereinafter, referred to as CMOS) , in which CMOS (Complementary Metal Oxide Semiconductor) consuming less power is incorporated in the pixel region of the matrix type as the photoelectric sensing element, is increasingly adopted as an option for solving the issue of the power consumption.

One of the characteristics of the CMOS is that the charges are read by means of the focal-plane shutter because the CMOS does not have the synchronism in reading the charges, which is different to the CCD. In the CCD, when the storage of the next charge is commenced after charge information of the irradiated light is read, the readout can start substantially synchronously in all of the pixels (synchronism in reading). In the CMOS, because the charge stored in a pixel is instantly amplified and read as a signal, the signal is read in the order of the pixels (non-synchronism in reading). In the CMOS, therefore, the next charge is immediately stored in the pixel read as the signal. Therefore, the charge is stored in the pixel respectively at different times in the case of a pixel from which the charge signal is first read at, for example, a vertically uppermost and horizontally leftmost position in the entire pixels and in the case of a pixel from which the charge signal is last read at a vertically lowermost and horizontally rightmost position. Therefore, in the CMOS, when the readout is executed, for example, in the horizontal direction, a timing for starting the exposure is shifted in the vertical direction, as a result of which the synchronism in an image is lost. As a result, an image sort of strained is obtained when a photographic subject moving fast is imaged.

Thus, in the CMOS in which the readout is executed by means of the focal-plane shutter, there is no synchronism in reading the charge unlike the CCD. Because of that, in the case of the pre-strobo light emission, it is not possible to obtain accurate data from the photoelectric sensing element of the CMOS type unless the light is emitted after all of horizontal scanning lines are in an exposure state.

For example, in the case of the focal-plane shutter shown in FIG. 8, all of exposure data subjected to the pre-strobo light emission can be read in a pre-strobo light emission 2 at a timing t2, while, in a pre-strobo light emission 1 at a timing t1, any data other than the data not subjected to the pre-strobo light emission cannot be read in the exposure data of a (n+1) line and the following lines which fails to obtain accurate data. In order to solve the problem, a method in which block data in a central region is sampled and used as AE data is available in the case of the photoelectric sensing element of the CMOS type randomly accessible (see the Patent Literature 1) .

In the solid image pickup device of the MOS type, the imaging is carried out by momentarily increasing the light volume by the strobo light emission with respect to an object to be photographed in the shortage of the light volume in an indoor dark place or nighttime. In the solid image pickup device of the CCD type, a control operation required for adjusting the exposure time, iris control and white balance are time consuming because image block data required for the AE is read by one frame. Therefore, the pre-strobo light emission is implemented prior to the real strobo light emission and an operation process is executed to data thereby obtained, based on which the exposure time and iris are controlled prior to the real strobo light emission.

The pre-strobo light emission is also necessary in the photoelectric sensing element of the MOS type represented by the photoelectric sensing element of the CMOS type in which the readout is executed by means of the focal-plane shutter. However, there is no synchronism in the charge storage. Therefore, aper-line charge storing time, that is a light volume measuring time, is shifted in storing the charge to measure the light volume. In such a case, a shift is generated in the timing per line in storing the light volume for the AE with respect to the momentarily light emission from the strobo including the pre-strobo light emission. As a result, the light from the pre-strobo light emissionis disadvantageously shifted from an AE evaluation region.

In order to improve the synchronism in the charge storage, the technology recited in the Patent Literature 1, wherein the readout is executed to a partial region by means of the photoelectric sensing element randomly accessible, does not employ the AE process using the exposure data of the entire pixels or the exposure data corresponding to an entire screen (entire region of the photographic subject). Thereby, there was a problem that the exposure time, iris control and white balance adjustment could not be accurately implemented.

### SUMMARY OF THE INVENTION

The present invention implements the following steps in order to solve the foregoing problems.

According to the present invention, data of respective pixels in a pre-strobo light emission are mixed, and the data of the entire pixels are read. Further, the data of the entire pixels, which are mixed and read in the pre-strobo light emission, are used for AE control in a real strobo light emission.

According to the present invention, the data of the respective pixels in the pre-strobo light emission are line-thinned, and pixel data corresponding to an entire screen region are read. Further, the pixel data corresponding to the entire screen region line-thinned in the pre-strobo light emission and read are used for the AE control in the real strobo light emission.

The pixel-data mixing and line-thinning methods are selectively used depending on conditions such as brightness. More specifically, when a photographic subject is bright, the line-thinning method is employed in the pre-strobo light emission, while the pixel-data mixing method is employed in the pre-strobo light emission in order to gain a signal level when the photographic subject is dark as a possible constitution. For example, the signal level corresponding to, for example, nine pixels can be used as the data of a pixel by the pixel-data mixing, and the image data having a favorable S/N can be obtained even in a dark place.

As another possible constitution, irrespective of the AE control, the signal level and white balance are calculated and a conversion value with respect to exposure data after the real strobo light emission is operated from a result of the calculation so as to generate optimum image data.

The present invention is more specifically described.

An image pickup device according to the present invention comprises at least a strobo for illuminating a photographic subject, a solid imaging element having a plurality of pixels disposed in a two-dimensional matrix shape, a strobo light emission control circuit for controlling the strobo and a sensor drive circuit for controlling storage/readout of a charge of the solid imaging element.

The strobo light emission control circuit controls the strobo so that the pre-strobo light emission is carried out prior to the real strobo light emission. The sensor drive circuit controls the solid imaging element so that the charges stored in the plurality of pixels are mixed and read per a predetermined number of pixels during the pre-strobo light emission.

According to the foregoing constitution, an accurate volume of light can be detected in the pre-strobo light emission prior to the real strobo light emission by using the pixel-data mixing facility. In addition, an exposure value and a gain value of the white balance can be adjusted in the real strobo light emission.

An image pickup device according to the present invention comprises at least a strobo for illuminating a photographic subject, a solid imaging element having a plurality of pixels disposed in a two-dimensional matrix shape, a strobo light emission control circuit for controlling the strobo and a sensor drive circuit for controlling storage/readout of a charge of the solid imaging element.

The strobo light emission control circuit controls the strobo so that the pre-strobo light emission is carried out prior to the real strobo light emission. The sensor drive circuit controls the solid imaging element so that the charges stored in the plurality of pixels are line-thinned and read per a predetermined number of lines during the pre-strobo light emission.

According to the foregoing constitution, an accurate volume of light can be detected in the pre-strobo light emission prior to the real strobo light emission by using the line-thinning facility. In addition, an exposure value and a gain value of the white balance can be adjusted in the real strobo light emission.

The sensor drive circuit is preferably adapted to read the pixel data corresponding to the entire screen region of the solid imaging element at the time of the pre-strobo light emission.

The image pickup device preferably further comprises a block operation circuit for block-dividing the pixel data corresponding to the entire screen region read at the time of the pre-strobo light emission and an AE control circuit for calculating an optimum shutter speed and iris value at the time of the real strobo light emission based on the block-divided pixel data.

The image pickup device preferably further comprises an AWB circuit for calculating the white balance based on the block-divided pixel data.

The image pickup device preferably converts the white balance calculated at the time of the pre-strobo light emission to thereby decide the white balance in the real strobo light emission.

The image pickup device preferably calculates an optimum signal level based on the block-divided pixel data.

The image pickup device preferably converts the optimum signal level calculated at the time of the pre-strobo light emission to thereby decide the signal level at the time of the real strobo light emission.

The predetermined number of pixels mixed based on the block-divided pixel data is preferably pixel data of a same color, and all of the pixels are preferably mixed and read.

An image pickup device according to the present invention comprises at least a strobo for illuminating a photographic subject, a solid imaging element having a plurality of pixels disposed in a two-dimensional matrix shape, a strobo light emission control circuit for controlling the strobo and a sensor drive circuit for controlling storage/readout of a charge of the solid imaging element.

The strobo light emission control circuit controls the strobo so that the pre-strobo light emission is carried out prior to the real strobo light emission. The sensor drive circuit controls the solid imaging element by selecting from two drive methods, which are a first drive method in which the charges stored in the plurality of pixels are mixed and read per a predetermined number of pixels during the pre-strobo light emission and a second drive method in which the charges are thinned and read per a predetermined number of lines during the pre-strobo light emission.

According to the foregoing constitution, the pixel-data mixing method is employed so as to carry out the pre-strobo light emission in order to gain the signal level when the photographic subject is dark, and the data is line-thinned so as to carry out the pre-strobo light emission when the photographic subject is bright. The image data of the favorable S/N can be obtained even in the dark place by employing the pixel-data mixing method.

A timing for implementing the pre-strobo light emission and a timing for initiating the exposure with respect to the entire pixels are preferably stored in a memorizing device in advance.

### BRIEF DESCRIPTION OF THE DRAWINGS

The present invention is illustrated be way of example and not limitation in the figures of the accompanying drawings, in which like references indicate similar elements in which:

FIG. 1 is a block diagram illustrating an entire constitution of a solid image pickup device according to a preferred embodiment of the present invention.

FIG. 2 illustrates an action of the solid image pickup device according to the preferred embodiment in the case of employing a pixel-data mixing method and a relationship between the action and pre-strobo light emission.

FIG. 3 is a conceptual diagram of the pixel-data mixing according to the preferred embodiment.

FIG. 4 FIG. 2 illustrates an action of the solid image pickup device according to the preferred embodiment in the case of employing a line-thinning method and a relationship between the action and pre-strobo light emission.

FIG. 5 is a flow chart of an action of the solid image pickup device according to the preferred embodiment.

FIG. 6 is a flow chart of an action of the solid image pickup device according to the preferred embodiment.

FIG. 7 shows conversion examples of an electronic shutter in the case of the pre-strobo light emission and a real strobo light emission in the solid image pickup device according to the preferred embodiment.

FIG. 8 illustrates an action of a photoelectric sensing element provided with a focal-plane shutter and a relationship between the action and the pre-strobo light emission.

FIG. 9A is an illustration of a problem in a conventional technology.

FIG. 9B is an illustration of another problem in the conventional technology.

### DESCRIPTION OF THE A PREFERRED EMBODIMENT

Hereinafter, a solid image pickup device according to a preferred embodiment of the present invention is described in detail referring to the drawings.

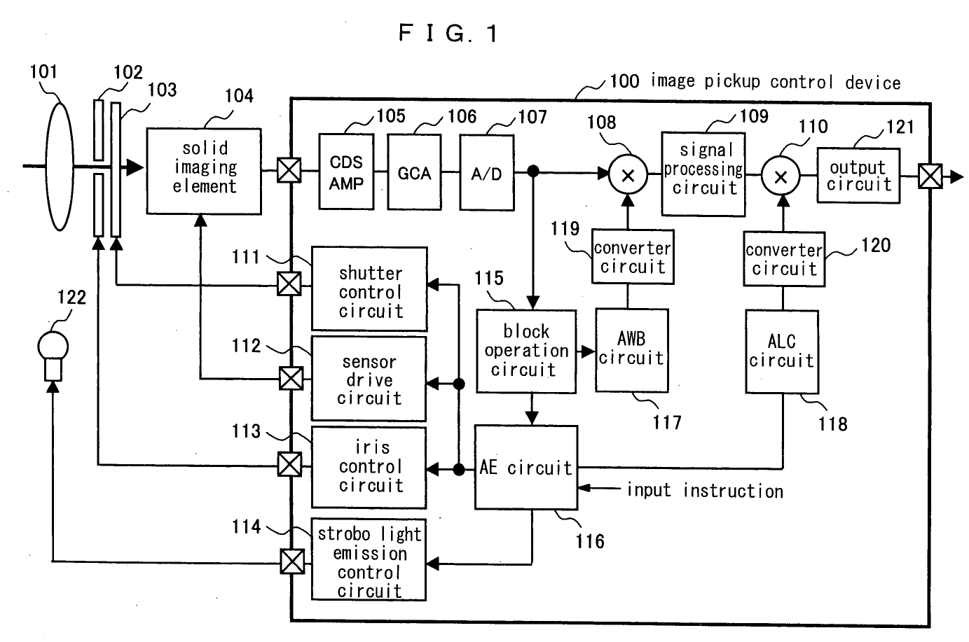

FIG. 1 shows an entire constitution of a solid image pickup device according to a preferred embodiment of the present invention. The slid image pickup device comprises a group of lenses 101, an iris 102, an electronic shutter 103, a solid imaging element 104, a strobo 122 and an image control unit 100. The solid imaging element is a photoelectric sensing element of MOS type for executing a focal-plane shutter readout.

Lights from a photographic subject are condensed on the groups of lenses 101. The iris 102 adjusts a light volume and a focus depth of the condensed lights. The electronic shutter 103 adjusts an exposure. The solid imaging sensor 104 photo-electrically converts the condensed lights of the photographic subject. A noise and offset of an output of the solid imaging sensor 104 is cancelled by a CDS (Correlated Double Sampling) AMP 105, and then, subjected to a gain adjustment implemented by a GCA (Gain Control Amp) 106 and converted into a digital signal by an A/D converter 107.

The digital signal from the A/D converter 107 is subjected to an operation executed by a block operation circuit 115. An AE control circuit 116 executes an AE control in accordance with a result of the operation of the block operation circuit 115.

In the AE control, a shutter control circuit 111 controls opening/closing of the shutter. A sensor drive circuit 112 controls the exposure/readout of the solid imaging element 104. An iris control circuit 113 controls the iris 102. A strobo light emission control circuit 114 controls a light emission timing/light emission time of the strobo 122. The strobo 122 carries out the strobo light emission under the control of the strobo light emission control circuit 114.

An AWB (Auto White Balance) circuit 117 executes an operation of a white balance to thereby obtain a desired image quality in accordance with a result of the operation of the block operation circuit 115. An ALC (Auto Luminescence Control) circuit 118 adjusts a signal level. Converter circuits 119 and 120 convert a signal depending on respective modes. Multipliers 108 and 110 multiply the digital signal by a value obtained by the conversion. A signal processing circuit 109 executes a predetermined signal process. An output circuit 121 outputs an image obtained from the photographic subject as the digital signal.

The solid imaging element 104 comprises a plurality of pixels (photoelectric sensing element) and a color filter in which a predetermined color for each pixel is, for example, Bayer-type arrayed.

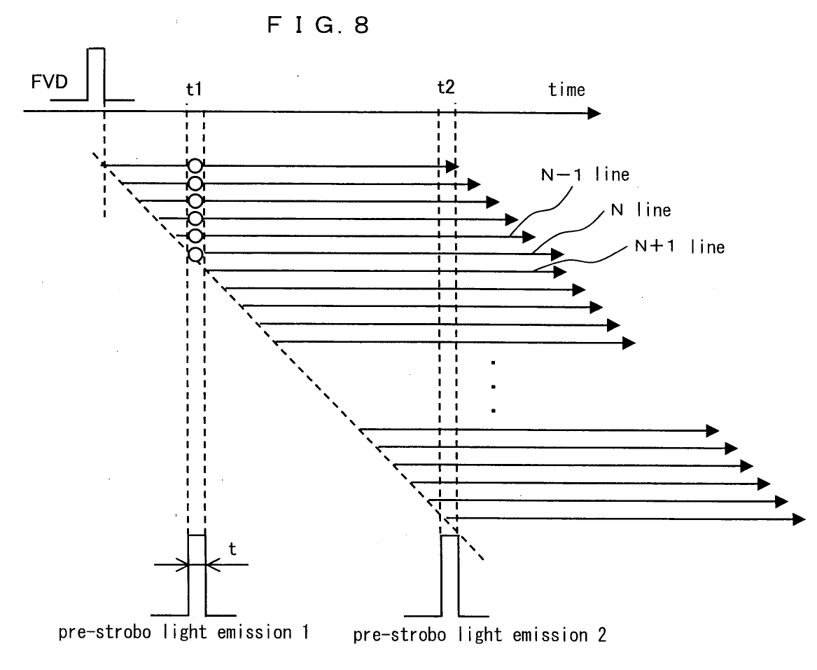

Next, an action of the solid image pickup device is described referring to FIGS. 1, 2 and 8.

In a preview state prior to the strobo light emission (prior to imaging a still image), the light from the photographic subject is focused on the solid imaging element 104 through the group of lenses 101 and the iris 102 and photo-electrically converted by the solid imaging element 104. A photoelectric conversion signal (image data) transmits through the CDSAMP 105 and the GCA 106, and digital-converted by the A/D converter 107 and inputted to the block operation circuit 115. The block operation circuit 115 executes an operation of the image data based on the digital signal from the A/C converter 107 and inputs a result of the operation to the AE control circuit 116.

The AE control circuit 116 calculates an optimum iris value, shutter speed and the like necessary for the AE control based on the operation result and inputs a result of the calculation to the shutter control circuit 111, sensor drive circuit 112, iris control circuit 113 and strobo light emission control circuit 114. The iris control circuit 113 and the shutter control circuit 111 controls the iris 102 and the electronic shutter 103 based on the calculated iris value, shutter speed and the like.

The AWB control circuit 117 calculates an optimum white balance based on the data obtained by the operation by the block operation circuit 115 and inputs a result of the calculation to the converter circuit 119. The output of the A/C converter circuit 107 and the output of the converter circuit 119 are multiplied for each color in the multiplier 108, and a result of the multiplication is inputted to the signal processing circuit 108. The signal processing 109 executes a signal process based on the input and inputs a result of the process to the multiplier 110. The ALC circuit 118 implements an adjustment so as to obtain the optimum signal level based on the output of the AE control circuit 116 and inputs a result of the adjustment to the converter circuit 120. The converter circuit 120 executes a conversion to the adjustment result and inputs a result of the conversion to the multiplier 110. The multiplier 110 multiplies the output of the signal processing circuit 109 and the output of the converter circuit 120 with respect to each other and outputs a result of the multiplication to the output circuit 121.

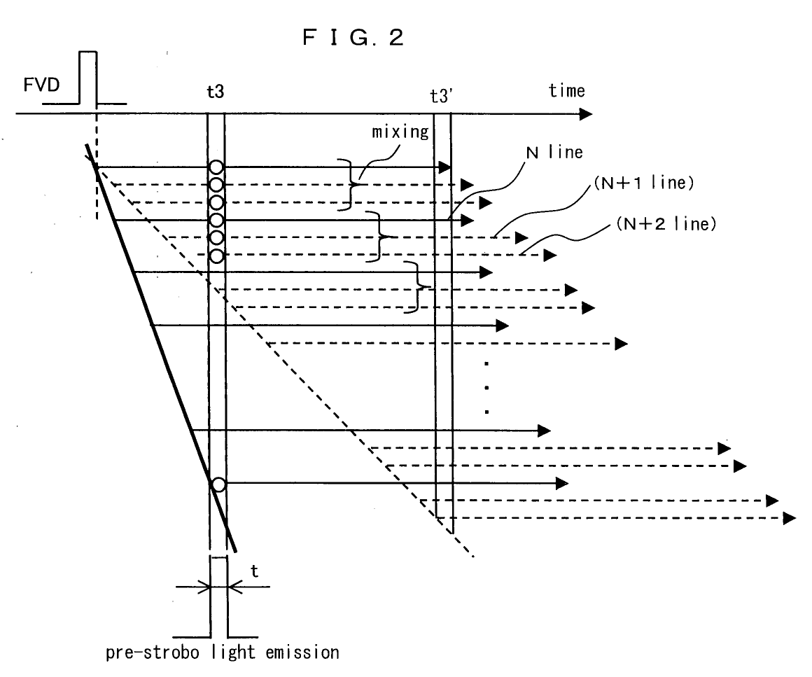

Below is described a strobo photography according to the present embodiment in the solid image pickup device constituted as described for executing the foregoing action. In the strobo photography, a microcomputer not shown inputs an instruction to the AE control circuit 116 when the shutter is pressed. The AE control circuit 116 controls the respective circuits 111 through 114 in response to the instruction. More specifically, the strobo light emission control circuit 114 is adapted to control the strobo 122 so that a pre-strobo light emission is carried out prior to a real strobo light emission. The sensor drive circuit 113 is adapted to control the solid imaging element 104 so that charges stored in the plurality of pixels in the solid imaging element 104 are mixed and read per a predetermined number of pixels during the pre-strobo light emission. When the pixels are thus mixed, the pixels can be quickly read, as a result of which a timing for starting the exposure of each pixel can be accelerated in contrast to reading all of the pixels in a simple manner. FIG. 2 shows a conceptual diagram illustrating the advantage. In FIG. 2, a solid line shows the timing for starting the exposure of each pixel in the case of the employing the pixel-data mixing method, while a broken line shows the timing for starting the exposure of each pixel without employing the pixel-data mixing method.

In the case of the pixel-data mixing method, as shown in FIG. 2, when a timing T3 has been reached after the shutter is pressed at a timing FVD, the exposure (charge storage) can be initiated with respect to al of the pixels. Therefore, an optimum AE can be realized because exposure data subjected to the pre-strobo light emission can be read from all of the pixels though the pre-strobo light emission is carried out at the relatively early timing t3.

In contrast to that, when the pixel-data mixing is not employed, the exposure can be initiated with respect to only a part of the pixels, while the exposure of the other pixels is not allowed to be initiated at the timing t3. Therefore, it is not possible to read the exposure data subjected to the pre-strobo light emission with respect to all of the pixels when the pre-strobo light emission is carried out at the timing t3. As a result, the optimum AE cannot be realized because only the exposure data not affected by the pre-strobo light emission can be read among the part of the pixels when the pre-strobo light emission is carried out at the timing t3. In order to realize the optimum AE without the pixel mixing, it is necessary to carry out the pre-strobo light emission at a timing t3′ temporally behind the timing t3. In doing so, the exposure data affected the pre-strobo light emission can be read from all of the pixels. However, the timing for initiating the readout of the exposure data (timing for initiating the exposure) is unfavorably delayed.

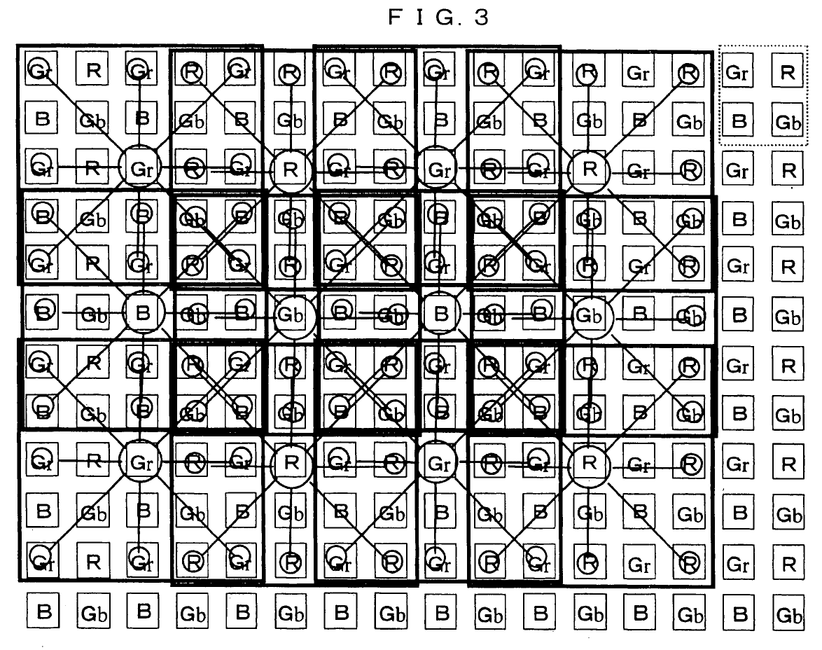

FIG. 3 shows an exemplified concept of the pixel-data mixing. In the example shown in FIG. 3, data corresponding to nine pixels of 3×3 having a same color is mixed into a pixel position of the same color in a central part. When the pixels are thus mixed, number of the pixels to be processed can be reduced, and the timing for starting the exposure with respect to each pixel can be thereby accelerated. Further, the deterioration of an information volume can be controlled because all of the pixels are used though mixed (looking at the central region in the drawing, it is understood that all of the pixels are mixed). The timing for starting the exposure can be accelerated, which consequently accelerates the timing for the pre-strobo light emission. Further, an entire region of the photographic subject and all of the pixel data can be used so as to calculate the AE, which realizes the optimum AE.

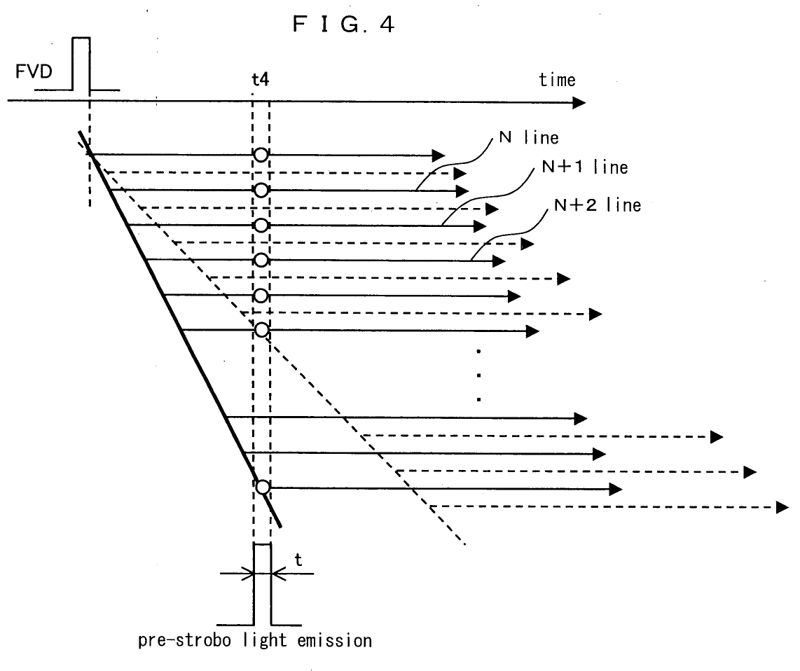

Further, according to the present embodiment, the data can be line-thinned and read from the solid imaging element 104 at the time of the pre-strobo light emission. When the pixels are line-thinned and read, the pixels can be quickly read, and the timing for starting the exposure of each pixel can be consequently accelerated in contrast to reading all of the pixels in a simple manner. FIG. 4 is a conceptual diagram thereof, wherein an solid line denotes the timing for starting the exposure of each pixel in the case of employing the line-thinning method.

As shown in FIG. 4, when the line-thinning method is employed, the exposure can be initiated with respect to the pixels of the entire region of the photographic subject at a timing t4. Therefore, when the pre-strobo light emission is carried out at the timing t4, the exposure data corresponding to the entire pixels can be stored and read. Then, the optimum AE can be realized because the exposure data corresponding to the entire pixels can be read.

The timing for the pre-strobo light emission and the timing for initiating the exposure with respect the pixels of the entire region can be memorized in advance in a memorizing device such as a register.

The present invention is compared to a conventional technology recited in the Patent Literature 1.

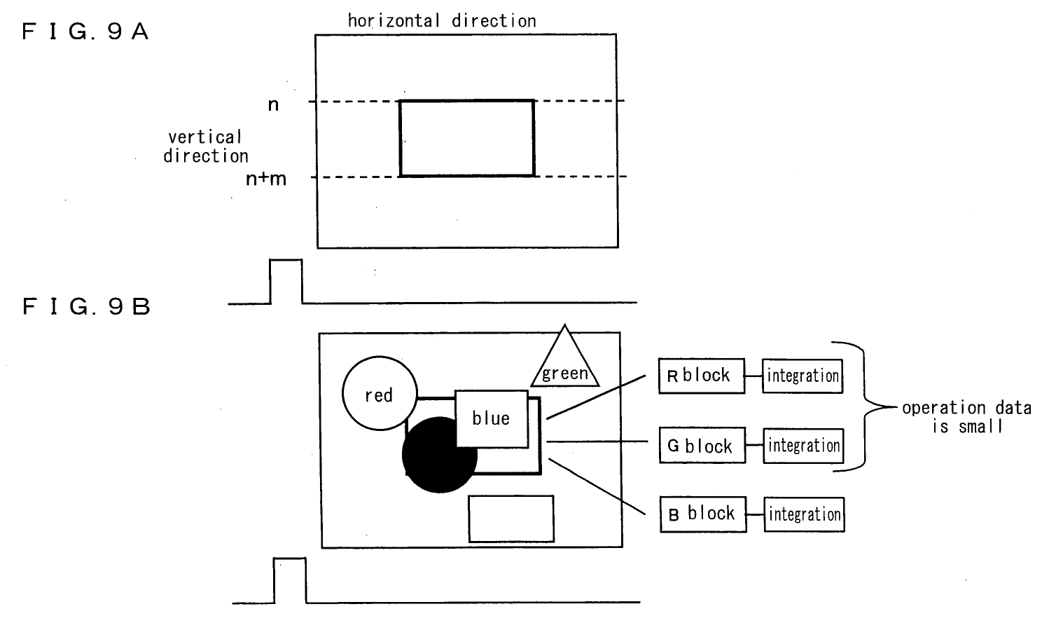

In the Patent Literature 1, a photoelectric sensing element randomly accessible, as shown in FIG. 9A, is utilized so that block data in a specific frame at the center of the drawing is read and used as data of the exposure control, auto white balance adjustment and AF control.

However, as shown in FIG. 9B, when the photographic subject necessary in terms of the exposure data is outside the specific frame, a large error was conventionally generated in the AE control. In controlling the iris and the exposure time, for example, when a bright photographic subject is outside the block, the exposure time is extended at the time of the real strobo light emission and peripheral photographic subjects are saturated, which generates a white void (Dynamic Range Over). In the case of adjusting the white balance at the time of the pre-strobo light emission, the technology recited in the Patent Literature 1 will result in a failure of an accurate adjustment in the presence the photographic subjects having different colors inside and outside the specific frame. In contrast to the conventional technology, the white balance can be adjusted to be even on the entire screen achieving an optimum white balance level.

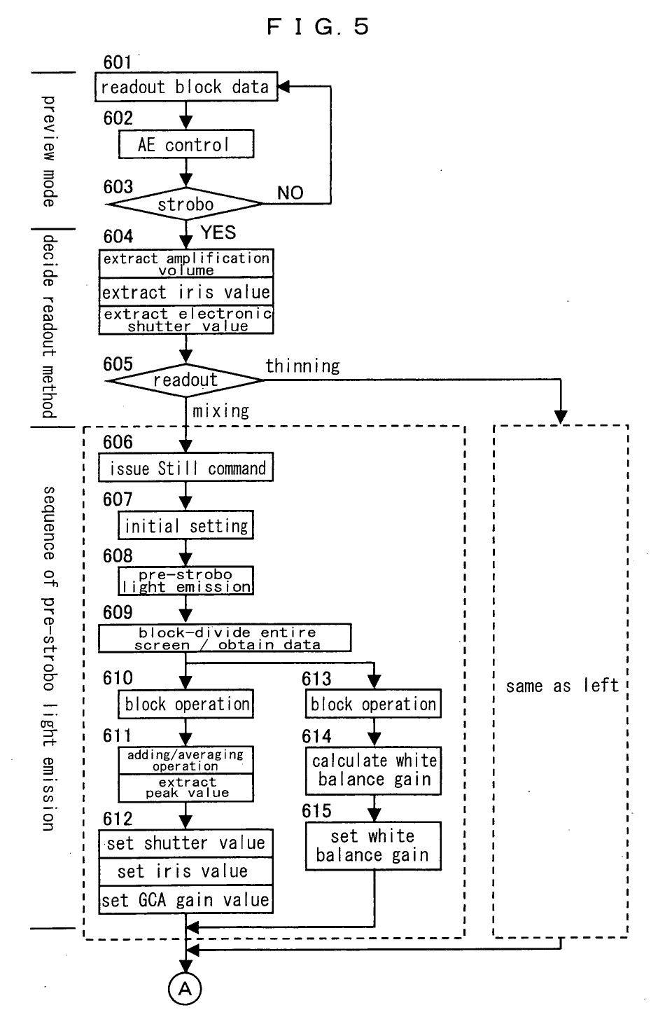

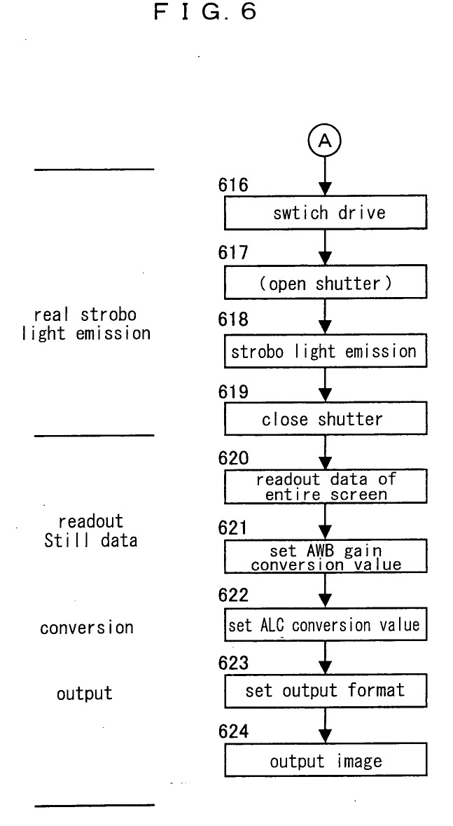

Next, the action of the solid image pickup device according to the present embodiment is described referring to flow charts of FIGS. 5 and 6.

In the solid image pickup device, the optimum AE control in response to the photographic subject is being executed in the preview state before a command of imaging a still image is issued. At that time, an amplification value is read from the GCA 106, iris value is read from the iris control circuit 113, and electronic shutter value is read from the sensor drive circuit 112 so as to judge the brightness. Thereby, it is decided if the stored charges after the pre-strobo light emission are read by means of the pixel-data mixing or line-thinning methods (Step S604). There is no difference in any process thereafter between the pixel-data mixing and the line-thinning methods except for a direction of the readout with respect to the solid imaging element 104. Any part in a broken-line box shows an identical process between the pixel-data mixing and the line-thinning methods.

Next, the strobo light emission control circuit 114 transmits a light emission signal to the strobo 122 after the command of imaging the still image (still command) is issued (Step S606), and the re-strobo light emission is thereby carried out. Thereafter, the pixel data in which the charge is stored is read by means of the selected method (Step S609: pixel-data mixing method) . The read data, as described earlier, transmits through the CDSAMP 105, GCA 106 and A/D converter 107 and is inputted to the block operation circuit 115 for dividing the entire screen, and then, added and averaged using a weighting previously set in each divided block. Further, a peak value of maximum data is calculated (Step S610).

The electronic shutter value, iris value and amplification value of the GCA at the time of the real strobo light emission are calculated based on the operation data and set in the sensor drive circuit 112 and the iris control circuit 113 (Step S612).

In the white balance adjustment, the gain value of the white balance (gain value per color) is calculated from the average value of the entire screen and set in the AWB circuit 117 (Step S615).

When the foreign settings have been completed, the sensor drive is switched so as to open the electronic shutter 103 by the shutter control circuit 111, and the real strobo light emission is carried out. The electronic shutter 103 is then closed and the exposure data is read. All of the pixels are read, transmitted through the CDSAMP 105, GCA 106 and A/C converter 107, multiplied by the gain value of the white balance in the multiplier 108, image-processed in the signal processing circuit 109, multiplied in the multiplier 110 by the ALC-level operation value calculated in the ALC circuit 118, adjusted in terms of a luminance level, and thereafter, format-converted in the output circuit 121 and outputted as the image.

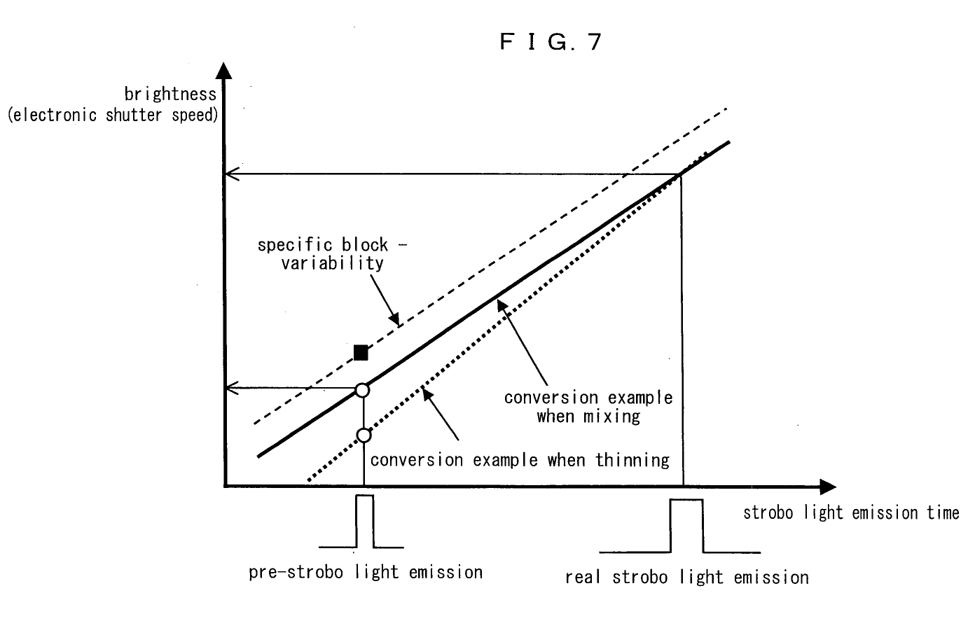

At that time, the processing time can be shortened when the ALC level operation value and the gain value of the white balance are multiplied by a value obtained by converting the value at the time of the pre-strobo light emission (FIG. 7). As shown in FIG. 7, a conversion expression is changed when the charge readout is decided because a tilting angle of the conversion is different in the case of the line-thinning method.

In the foregoing flowcharts, the pixel-data mixing method or the line-thinning method is selectively employed, however, only one of the two methods may be fixedly selected. In the case of selecting only one of them, the pre-strobo light emission can be carried out at an early timing using the exposure data corresponding to the entire pixels or the entire screen. Therefore, the object of the present invention, that is to quickly obtain the optimum AE, can be achieved.

Further, according to the present invention, all of the AE, ALC level operation value and gain value of the white balance are calculated through the conversion based on the value calculated at the time of the pre-strobo light emission. However, a part of the values may be calculated at the time of the pre-strobo light emission, while the rest of them may be calculated at the time of the real strobo light emission.

The solid image pickup device according to the present invention is effectively utilized for a mobile telephone provided with a photographing function, a digital still camera and the like.

While the present invention has been described and illustrated in detail, it is to be clearly understood that this is intended be way of illustration and example only and is not to be taken by way of limitation, the spirit and scope of the invention being limited only be the terms of following claims.

1. An image pickup device comprising:
at least a strobo for illuminating a photographic subject;
a solid imaging element having a plurality of pixels disposed in a two-dimensional matrix shape;
a strobo light emission control circuit for controlling the strobo; and
a sensor drive circuit for controlling storage/readout of a charge of the solid imaging element, wherein
the strobo light emission control circuit controls the strobo so that a pre-strobo light emission is carried out prior to a real strobo light emission, and
the sensor drive circuit controls the solid imaging element so that the charges stored in the plurality of pixels are mixed and read per a predetermined number of pixels during the pre-strobo light emission.

2. An image pickup device as claimed in claim 1, wherein the sensor drive circuit reads pixel data corresponding to an entire screen region of the solid imaging element at the time of the pre-strobo light emission.

3. An image pickup device as claimed in claim 1, further comprising:
a block operation circuit for block-dividing pixel data corresponding to an entire screen region read at the time of the pre-strobo light emission; and
an AE control circuit for calculating an optimum shutter speed and iris value at the time of the real strobo light emission based on the block-divided pixel data.

4. An image pickup device as claimed in claim 3, further comprising an AWB circuit for calculating a white balance based on the block-divided pixel data.

5. An image pickup device as claimed in claim 4, wherein
a white balance at the time of the real strobo light emission is decided by converting the white balance calculated at the time of the pre-strobo light emission.

6. An image pickup device as claimed in claim 3, wherein
an optimum signal level is calculated based on the block-divided pixel data.

7. An image pickup device as claimed in claim 6, wherein
a signal level at the time of the real strobo light emission is decided by converting the optimum signal level calculated at the time of the pre-strobo light emission.

8. An image pickup device as claimed in claim 3, wherein
the predetermined number of pixels mixed based on the block-divided pixel data is pixel data of a same color, and all of the pixels are mixed and read.

9. An image pickup device as claimed in claim 1, wherein
a timing for implementing the pre-strobo light emission and a timing for initiating an exposure with respect to all of the pixels are stored in a memorizing device in advance.

10. An image pickup device comprising:
at least a strobo for illuminating a photographic subject;
a solid imaging element having a plurality of pixels disposed in a two-dimensional matrix shape;
a strobo light emission control circuit for controlling the strobo; and
a sensor drive circuit for controlling storage/readout of a charge of the solid imaging element, wherein
the strobo light emission control circuit controls the strobo so that a pre-strobo light emission is carried out prior to a real strobo light emission, and
the sensor drive circuit controls the solid imaging element so that the charges stored in the plurality of pixels are line-thinned and read per a predetermined number of lines during the pre-strobo light emission.

11. An image pickup device as claimed in claim 10, wherein
the sensor drive circuit reads pixel data corresponding to an entire screen region of the solid imaging element at the time of the pre-strobo light emission.

12. An image pickup device as claimed in claim 10, further comprising:
a block operation circuit for block-dividing pixel data corresponding to an entire screen region read at the time of the pre-strobo light emission; and
an AE control circuit for calculating an optimum shutter speed and iris value at the time of the real strobo light emission based on the block-divided pixel data.

13. An image pickup device as claimed in claim 12, further comprising an AWB circuit for calculating a white balance based on the block-divided pixel data.

14. An image pickup device as claimed in claim 13, wherein
a white balance at the time of the real strobo light emission is decided by converting the white balance calculated at the time of the pre-strobo light emission.

15. An image pickup device as claimed in claim 12, wherein
an optimum signal level is calculated based on the block-divided pixel data.

16. An image pickup device as claimed in claim 15, wherein
a signal level at the time of the real strobo light emission is decided by converting the optimum signal level calculated at the time of the pre-strobo light emission.

17. An image pickup device as claimed in claim 12, wherein
the predetermined number of pixels line-thinned based on the block-divided pixel data is pixel data of a same color, and all of the pixels are line-thinned and read.

18. An image pickup device as claimed in claim 10, wherein
a timing for implementing the pre-strobo light emission and a timing for initiating an exposure with respect to all of the pixels are stored in a memorizing device in advance.

19. An image pickup device comprising:
at least a strobo for illuminating a photographic subject;
a solid imaging element having a plurality of pixels disposed in a two-dimensional matrix shape;
a strobo light emission control circuit for controlling the strobo; and
a sensor drive circuit for controlling storage/readout of a charge of the solid imaging element, wherein
the strobo light emission control circuit controls the strobo so that a pre-strobo light emission is carried out prior to a real strobo light emission, and
the sensor drive circuit controls the solid imaging element by selecting from two drive methods, which are a first drive method in which the charges stored in the plurality of pixels are mixed and read per a predetermined number of pixels during the pre-strobo light emission and a second drive method in which the charges are thinned and read per a predetermined number of lines during the pre-strobo light emission.

20. An image pickup device as claimed in claim 19, wherein
the solid imaging element is read by means of a focal-plane shutter.

21. An image pickup device as claimed in claim 19, further comprising a color filter provided in a front surface of the solid imaging element.

22. An image pickup method in which a photographic subject is illuminated by a strobo, and a light of the illuminated photographic subject is condensed on a solid image pickup device having a plurality of pixels disposed in a two-dimensional matrix shape so as to pick up an image of the photographic subject, comprising:
a step of implementing a pre-strobo light emission;
a step of storing charges in the plurality of pixels during the pre-strobo light emission;
a step of mixing and reading the charges stored in the plurality of pixels per a predetermined number of pixels during the pre-strobo light emission;
a step of calculating a shutter speed and an iris value at the time of the real strobo light emission using the mixed and read charges;
a step of implementing the real strobo light emission;
a step of storing the charges in the plurality of pixels based on the calculated shutter speed and iris value; and
a step of reading the stored charges from all of the pixels without the mixing process.

23. An image pickup method as claimed in claim 22, further comprising:
a step of calculating a white balance and/or a signal level using the charges stored in the plurality of pixels during the pre-strobo light emission; and
a step of deciding a white balance and/or a signal level at the time of the real strobo light emission by converting the calculated white balance and/or signal level.

24. An image pickup method in which a photographic subject is illuminated by a strobo, and a light of the illuminated photographic subject is condensed on a solid image pickup device having a plurality of pixels disposed in a two-dimensional matrix shape so as to pick up an image of the photographic subject, comprising:
a step of implementing a pre-strobo light emission;
a step of storing charges in the plurality of pixels during the pre-strobo light emission;
a step of line-thinning and reading the charges stored in the plurality of pixels during the pre-strobo light emission per a predetermined number of lines;
a step of calculating a shutter speed and an iris value at the time of the real strobo light emission using the line-thinned and read charges;
a step of implementing the real strobo light emission;
a step of storing the charges in the plurality of pixels based on the calculated shutter speed and iris value; and
a step of reading the stored charges from all of the pixels without the line-thinning process.
